(19) United States
(12) Patent Application Publication
(10) Pub. No.: US 2006/0210350 A1
(43) Pub. Date: Sep. 21, 2006

(54) Writing instrument with cap having the features of a head

(75) Inventor: Enrico Quercioli, Settimo Torinese (IT)

Correspondence Address: PATTERSON & SHERIDAN, L.L.P., 3040 POST OAK BOULEVARD, SUITE 1500, HOUSTON, TX, 77056, US

(73) Assignee: Universal S.p.A

(21) Appl. No.: 11/240,292

(22) Filed: Sep. 30, 2005

(30) Foreign Application Priority Data
Mar. 17, 2005 (IT) TO2005A000178

(51) Int. Cl. B43K 23/12; B43K 29/00

(52) U.S. Cl. 401/243; 401/195

(57) ABSTRACT

Writing instrument comprising a body and a removable cap, in which the cap has the features of a character's head, thereby providing the instrument as a whole with zoomorphic or anthropomorphic characteristics.

### CROSS-REFERENCE TO RELATED APPLICATIONS

This application claims benefit of Italian Patent Application serial number TO2005A000178, filed Mar. 17, 2005, which is herein incorporated by reference.

### FIELD OF THE INVENTION

The present invention relates to a writing instrument having a body and a removable cap.

### SUMMARY OF THE INVENTION

The object of the present invention is to provide an enhanced writing instrument meant in particular for children, which in addition to its primary function as felt-tip pen, pen or the like, also serves an auxiliary function as a play or collection element, in order to increase children's appreciation for said writing instrument.

According to the present invention, said object is achieved thanks to the fact that the removable cap has the features of a character's head, thereby providing the writing instrument as a whole with zoomorphic or anthropomorphic characteristics.

The writing instrument according to the present invention is in fact capable of being used as a play or collection element thanks to its zoomorphic or anthropomorphic features which, however, in no way compromise the primary function of the writing instrument.

The writing instrument according to the present invention can be associated to a small base forming a pedestal that enables to keep the writing instrument in the erect position to increase the possibilities of using the writing instrument for playing purposes. Said base can be used to position also the cap by itself. Various bases of the same type can be connected to each other according to a general “puzzle” configuration.

### BRIEF DESCRIPTION OF THE DRAWINGS

Additional characteristics and advantages of the present invention shall become readily apparent in the detailed description that follows, provided purely by way of non limiting example, with reference to the accompanying drawings, in which:
FIG. 1 is an elevation view of a writing instrument according to the present invention,
FIG. 2 shows the writing instrument of FIG. 1 with the cap extracted,
FIG. 3 is an axial section of the body of the writing instruments of FIGS. 1 and 2,
FIG. 4 is a perspective view of a cap for a writing instrument according to the invention,
FIG. 5 is a perspective view of a base usable as a pedestal for a writing instrument according to the invention, and
FIG. 6 is a perspective view that schematically shows various writing instruments according to the invention positioned on respective bases.

### DETAILED DESCRIPTION OF THE PREFERRED EMBODIMENT

With reference to FIGS. 1 through 3, the reference number 10 designates a writing instrument according to the present invention. In the illustrated example, the writing instrument 10 is constituted by a felt-tip pen. However, the present invention can also be used for other types of writing instruments with removable cap, such as ball point pens, fountain pens, etc. The writing instrument 10 comprises a body 12 and a removable cap 14, both preferably made of injection moulded plastic material.

The body 12 of the writing instrument 10 has an inner cavity 16 in which is housed a reserve of ink, e.g. in the form of a fibre pad imbued with ink. The cavity 16 communicates with an opening 18 in which is inserted a writing tip 20. The cavity 16 is closed on one side by a stopper 18 inserted by pressure in an end of the body 18. The outer part of the body 12 preferably has a shape that is tapered towards the writing tip and it has a part 22 with reduced diameter whereon the cap 14 is pressure fitted in removable fashion.

With reference to FIGS. 1, 2 and 4, the cap 14 has the features of a character's head. The cap 14 has a cylindrical portion 24 resembling the neck of the head. The cap 14 has an open cavity at the end of the cylindrical portion 24, into which the part 22 of the body 12 is pressure fitted. The outer surface of the cylindrical portion 24 can be pressure fitted into a hole 26 (FIG. 3) of the cap 18.

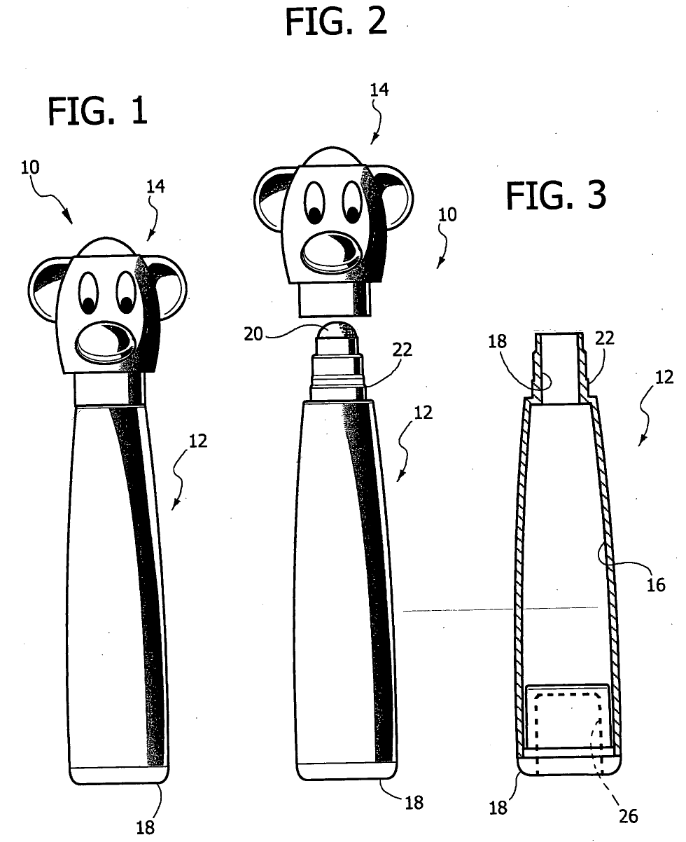

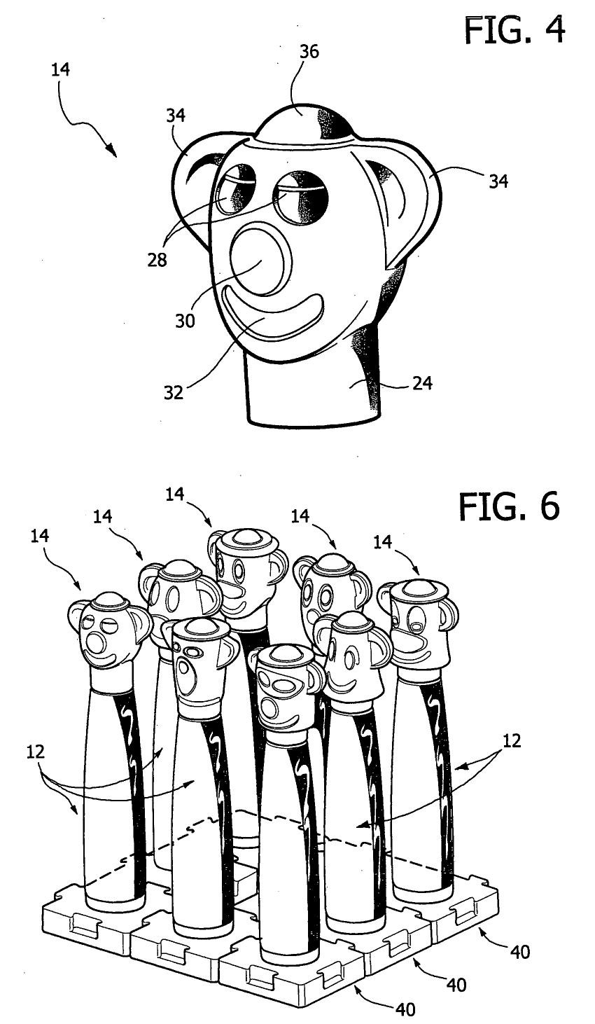

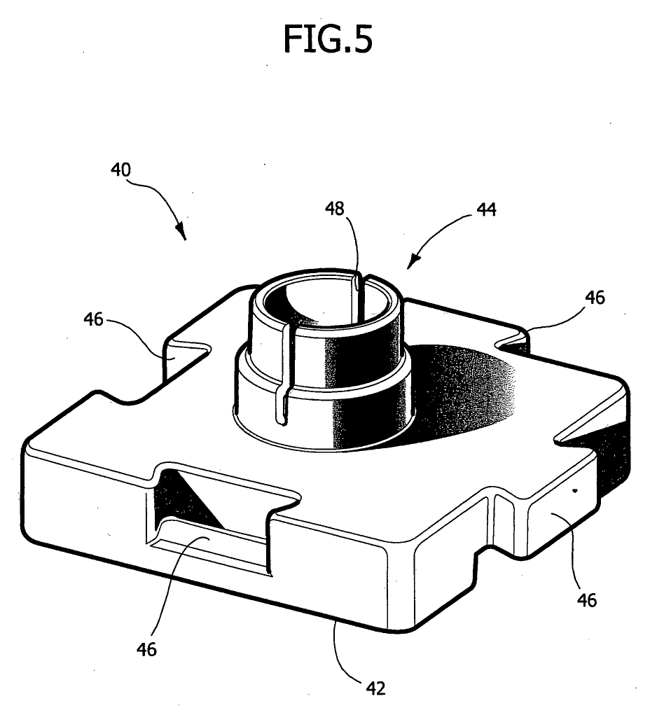

The head of the character is formed by a three dimensional body of plastic material whereon are formed recesses or projections 28, 30, 32 forming the characteristic elements of the character's face, e.g. the eyes 28, the nose 30 and the mouth 32. The shape of the recesses or projections 28, 30, 32 can vary for different caps to change the expression of the character's face and its features. The various caps can also have mutually different shapes to increase the number of characters represented. FIG. 6 shows by way of example a certain number of caps with the features of different characters.

The cap 14 is also provided with two integral projections with rounded shape which form the character's ears and which also serve the purpose of meeting the safety rules prescribed for writing instrument caps. The rules prescribe that if the cap were accidentally swallowed by a child, it must have sufficient air passages to prevent suffocation. The projecting portions 34 forming the character's ears perform the suffocation-prevention safety function prescribed by the safety rules. Said projections allow to prevent the presence, inside the body of the cap, of air passage holes, necessary if the cap lacks external projections. The dimensions of the projections 34 are determined in such a way as to render the cap 14 compliant with safety rules against suffocation. The projections 14 also serve the purpose of preventing the writing instrument 12 from rolling when it is set down on an inclined surface.

The cap 14 also has a hemispherical dome 36 which forms the top of the character's head. The purpose of the dome 36 is to allow the cap 14 to be gripped by a manipulator device with suction cups, used during the production process for the automatic assembly and the manipulation of the writing instruments.

The body forming the cap 14 can be constituted of coloured plastic material. In this case, the character's head and face have a uniform colour and the facial expressions are provided by the shadow effects of the recesses or projections 28, 30, 32. Alternatively, the character's face could have no projections and recesses and the facial expression could be painted on a planar or curved face of the cap.

The cap with the features of a character's head provides the writing instrument 10 as a whole with zoomorphic or anthropomorphic characteristics. The writing instrument can therefore be used as a play or collection element, possibly even after the ink reserve is depleted.

To expand the playing options connected to the use of the writing instrument according to the present invention, each writing instrument 10 can be associated to a base serving as a pedestal. An example of such a base is shown in FIG. 5. The base, designated by the number 40, is constituted by a body made of moulded plastic material having a bearing surface 42 and, on the opposite side, a projection 44 that can be inserted into the hole 26 of the body 12 or into the seat of the cap 12. The base 40 can be provided with press-fit formations 46 which allow to connect the base 40 to bases of the same kind according to a general “puzzle” configuration. FIG. 6 schematically shows various bases 40 mutually connected, on each of which is installed a respective writing instrument 12. The projecting portion 44 of the base 40 can also be provided with a slit 48 into which can be inserted, for example, a sheet of cardboard bearing images forming a scenery for the characters constituted by the writing instruments according to the invention.

Naturally, without altering the principle of the invention, the construction details and the embodiments may be widely varied from what is described and illustrated herein, without thereby departing from the scope of the invention, as defined by the appended claims.

In The Claims:

1. Writing instrument comprising:
a body;
a removable cap, wherein the cap has the features of a character's head, thereby providing the instrument with zoomorphic or anthropomorphic characteristics; and
a base in the manner of a pedestal whereon can be installed the body or the cap of the writing instrument and having press-fit formations which allow the mutual coupling of bases of the same type.

2. Writing instrument as claimed in claim 1, wherein the removable cap is formed by a monolithic body made of moulded plastic material provided with integral projections having the features of ears of the head and serving as a safety feature against suffocation in case of accidental swallowing.

3. Writing instrument as claimed in claim 1, wherein the cap comprises an integral dome with hemispherical shape forming the top of the head of the character and serving for the grip by a suction cup device.

4. Writing instrument as claimed in claim 1, wherein the cap is provided with recesses and/or projections which form characteristic traits of the character's face.

5. Writing instrument as claimed in claim 1, wherein the cap is provided with painted or printed images which form characteristic traits of the character's face.

6. Writing instrument as claimed in claim 1, wherein the cap has a cylindrical portion with the features of the neck of the characters head, said cylindrical portion being provided with a hole able to receive an end portion of the body of the writing instrument.

7-8. (canceled)

9. A writing Instrument, comprising:
a body, and
a removable cap having an open cavity at a first end for receiving a portion of the body, wherein the cap has features defining a head of a character, the features including:
opposing projections forming ears of the character; and
an integral dome apex with a hemispherical shape forming a top of the head disposed at a second end of the cap opposite the first end, wherein the dome apex extends in a direction from the first end toward the second end beyond the projections and is configured to enable gripping during assembly by a manipulator suction cup device.

10. A writing instrument as claimed in claim 9, wherein at least one of the body and the cap is configured for coupling with a base which allows mutual coupling of similar bases.

11. A writing instrument as claimed in claim 9, wherein one or more projections on the cap are configured to meet child safety choking requirements.

12. A writing instrument as claimed in claim 9, wherein the features provide the writing instrument with anthropomorphic characteristics.

13. A device for holding one or more writing instruments, comprising:
a base defining a pedestal configured to couple with at least one of a body and a cap of the writing instrument, wherein the base includes one or more press-fit formations which allow coupling of the base with another such base.

14. The device of claim 13, wherein a projection on the base is configured to couple with a seat of the cap.

15. The device of claim 13, wherein a projection on the base is configured to couple with a recess formed in the writing instrument.

16. The device of claim 13, wherein a projection on the base is configured to couple with with a seat of the cap and a recess formed in the writing instrument.
